(19) United States
(12) Patent Application Publication
(10) Pub. No.: US 2024/0305380 A1
(43) Pub. Date: Sep. 12, 2024

(54) LIGHT SOURCE DEVICE, OPTICAL DEVICE, CONTROL LIGHT GENERATION METHOD, AND TRANSMISSION LIGHT GENERATION METHOD

(71) Applicant: NEC Corporation, Minato-ku, Tokyo (JP)

(72) Inventor: Taketo Onuma, Tokyo (JP)

(73) Assignee: NEC Corporation, Minato-ku, Tokyo (JP)

(21) Appl. No.: 18/270,983

(22) PCT Filed: Jan. 12, 2021
(86) PCT No.: PCT/JP2021/000615

§ 371 Date: Jul. 5, 2023

(51) Int. Cl. H04B 10/508; H04B 10/25; H04B 10/564; H04B 10/572

(52) U.S. Cl. CPC H04B 10/508; H04B 10/25; H04B 10/564; H04B 10/572

(57) ABSTRACT

A light source device of the present invention includes: a light generation circuit that generates amplified spontaneous emission; a beam splitting circuit that splits the amplified spontaneous emission into a plurality of split light beams; and a light control circuit that controls the band and power of at least one of the plurality of split light beams to generate a waveform-shaped split light beam.

### TECHNICAL FIELD

The present invention relates to a light source device, an optical device, a control light generation method, and a transmission light generation method, more particularly to a light source device, an optical device, a control light generation method, and a transmission light generation method that are used in an optical submarine cable system.

### BACKGROUND ART

An optical submarine cable system in which continents are connected to one another via optical fibers is a key factor as an infrastructure that supports an international communication network. The optical submarine cable system includes a submarine cable that accommodates optical fibers, a submarine repeater that includes an optical amplifier, a submarine splitting device that splits an optical signal, a terminal device that is installed in a land station, and the like.

As a submarine splitting device, there has been introduced a light transmission device having a reconfigurable optical add/drop multiplexing (ROADM) function of wavelength-dividing or wavelength-multiplexing wavelength multiplexed lights from a plurality of different paths and then transmitting the lights. One example of such a light transmission device is described in PTL 1.

A related light transmission device described in PTL 1 includes a high-speed variable optical attenuator (VOA), a 1×k splitter (SPL), a light filter, and an amplified spontaneous emission (ASE) light source. The related light transmission device further includes a coupler (CPL) and an M×1 wavelength selective switch (WSS).

Herein, the light filter generates a dummy light having a light spectrum width equivalent to that of a signal light in a wavelength of each signal light, from a spontaneous emission light being output from the ASE light source. The 1×k SPL splits the dummy light being output from the light filter, into k, and outputs the lights into each of paths 1 to k. The high-speed VOA controls a light level of the dummy light for a path being determined to be abnormal, in such a way that a sum of a light level of a signal light determined to be abnormal and the light level of the dummy light is a predetermined target value.

The CPL multiplexes a signal light being output to a main-signal light transmission path and the dummy light being output from the high-speed VOA. Further, the M×1 WSS outputs, to a light transmission path being a path 1, a wavelength multiplexed light acquired by multiplexing a light being output from the CPL of each path to the main-signal light transmission path and a light inserted from a transmitter.

With this configuration, according to the related light transmission device, it is assumed that generation of an optical surge can be suppressed and degradation of a signal light subjected to multiplexing from another path can be suppressed.

Further, examples of the related art include techniques described in PTLs 2 and 3.

### CITATION LIST

### Patent Literature

PTL1: Japanese Unexamined Patent Application Publication No. 2015-95808
PTL2: Japanese Unexamined Patent Application Publication No. 2012-109653
PTL3: Japanese Unexamined Patent Application Publication No. 2000-174701

### SUMMARY OF INVENTION

### Technical Problem

As described above, in the related light transmission device described in PTL 1, there is adopted a configuration in which signal lights from each path to which a split dummy light is each added are multiplexed and a wavelength multiplexed light thus acquired through multiplexing is output to the same path. However, when a dummy light (control light) is added to a main signal light being output to different paths (light transmission paths), wavelength dependency of a loss and a gain differs for each light transmission path, and hence it is required to adjust a light spectrum of the control light, according to a characteristic of each light transmission path. Therefore, it is difficult to commonly share a light source of a control light. Thus, it is required to provide a light source of a control light for each light transmission path being an output destination of a main signal light, which leads to a size increase and a cost increase of the device.

Thus, with a configuration in which a control light is introduced into a plurality of light transmission paths, there is a problem of a size increase and a cost increase of the device.

An object of the present invention is to provide a light source device, an optical device, a control light generation method, and a transmission light generation method that solve a problem of a size increase and a cost increase of a device when a configuration in which a control light is introduced into a plurality of light transmission paths is adopted.

### Solution to Problem

A light source device according to the present invention includes a light generation means for generating an amplified spontaneous emission light, a light splitting means for splitting the amplified spontaneous emission light into a plurality of split lights, and a light control means for controlling a band and power of at least one of the plurality of split lights and generating a waveform-shaped split light.

A control light generation method according to the present invention includes generating an amplified spontaneous emission light, splitting the amplified spontaneous emission light into a plurality of split lights, and controlling a band and power of at least one of the plurality of split lights and generating a waveform-shaped split light.

### Advantageous Effects of Invention

According to the light source device, the optical device, the control light generation method, and the transmission light generation method of the present invention, a size increase and a cost increase of the device can be avoided even when a control light is introduced into a plurality of light transmission paths.

### BRIEF DESCRIPTION OF DRAWINGS

FIG. 1 is a block diagram illustrating a configuration of a light source device according to a first example embodiment of the present invention.

FIG. 2 is a block diagram illustrating a configuration of a light source device according to a second example embodiment of the present invention.

FIG. 3A is a diagram illustrating a spectrum of an amplified spontaneous emission light generated by a light generation unit included in the light source device according to the second example embodiment of the present invention.

FIG. 3B is a diagram illustrating a spectrum of a waveform-shaped split light generated by a light control unit included in the light source device according to the second example embodiment of the present invention.

FIG. 4 is a block diagram illustrating a configuration of a light source device according to a third example embodiment of the present invention.

FIG. 5 is a block diagram illustrating another configuration of the light source device according to the third example embodiment of the present invention.

FIG. 6 is a block diagram illustrating a configuration of an optical device according to a fourth example embodiment of the present invention.

### EXAMPLE EMBODIMENT

With reference to the drawings, example embodiments of the present invention are described below.

### First Example Embodiment

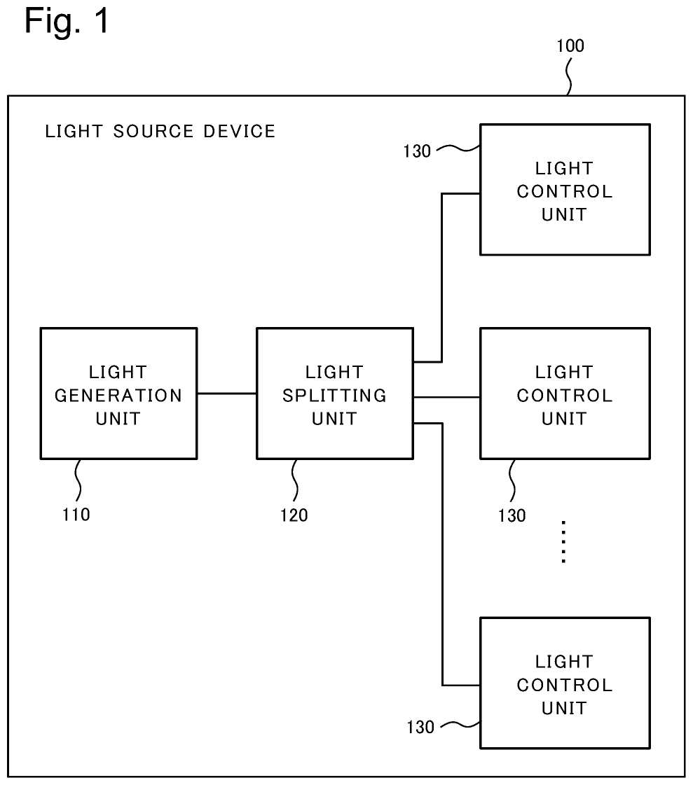

FIG. 1 is a block diagram illustrating a configuration of a light source device 100 according to a first example embodiment of the present invention. The light source device 100 includes a light generation unit (light generation means) 110, a light splitting unit (light splitting means) 120, and a light control unit (light control means) 130. The light source device 100 is suitably used in an optical submarine cable system.

The light generation unit 110 generates an amplified spontaneous emission light. The light splitting unit 120 splits the amplified spontaneous emission light into a plurality of split lights. Further, the light control unit 130 controls a band and power of at least one of the plurality of split lights to generate a waveform-shaped split light. FIG. 1 illustrates a configuration in which the plurality of light control units 130 are included and each of the light control units 130 generates a waveform-shaped split light.

As described above, in the light source device 100 of the present example embodiment, there is adopted a configuration in which the light splitting unit 120 splits the amplified spontaneous emission light into the plurality of split lights and the light control unit 130 controls the band and the power of the split light to generate the waveform-shaped split light. Thus, it is possible to introduce the waveform-shaped split light as a control light (dummy light) into a plurality of light transmission paths by using the single light generation unit 110 in a commonly shared manner. In other words, according to the light source device 100 of the present example embodiment, a size increase and a cost increase of the device can be avoided even when a control light is introduced into a plurality of light transmission paths.

Herein, the light generation unit 110 may be configured to include a light waveguide having a core containing a rare earth element, and an excitation laser that generates an excitation light for exciting the rare earth element. Specifically, for example, as the light generation unit 110, there may be used an amplified spontaneous emission (ASE) light source in which an amplifier using an erbium doped fiber as a light waveguide (Erbium Doped Fiber Amplifier: EDFA) is in a non-input signal state. The amplified spontaneous emission (ASE) light generated by the light generation unit 110 is an amplified spontaneous emission light having a continuous and broad light spectrum.

Typically, a light splitter of a multi-splitting type may be used as the light splitting unit 120.

The light control unit 130 may be configured to include a wavelength selective switch (WSS). The wavelength selective switch (WSS) is capable of adjusting an attenuation amount of power of an input light for each wavelength. The wavelength selective switch (WSS) has a one-input/one-output configuration, and thus an output light can be acquired by shaping a waveform of an input light in a freely selective manner.

Next, a control light generation method according to the present example embodiment is described.

In the control light generation method according to the present example embodiment, first an amplified spontaneous emission light is generated. Subsequently, the amplified spontaneous emission light is split into a plurality of split lights. After that, the band and the power of at least one of the plurality of split lights are controlled to generate a waveform-shaped split light.

Herein, generating the amplified spontaneous emission light described above may include exciting the rare earth element contained in the core of the light waveguide with an excitation light. Further, there may be adopted a configuration in which generating the waveform-shaped split light described above includes adjusting the power of at least one of the plurality of split lights for each wavelength.

As described above, according to the light source device 100 and the control light generation method of the present example embodiment, a size increase and a cost increase of the device can be avoided even when a control light is introduced into a plurality of light transmission paths.

### Second Example Embodiment

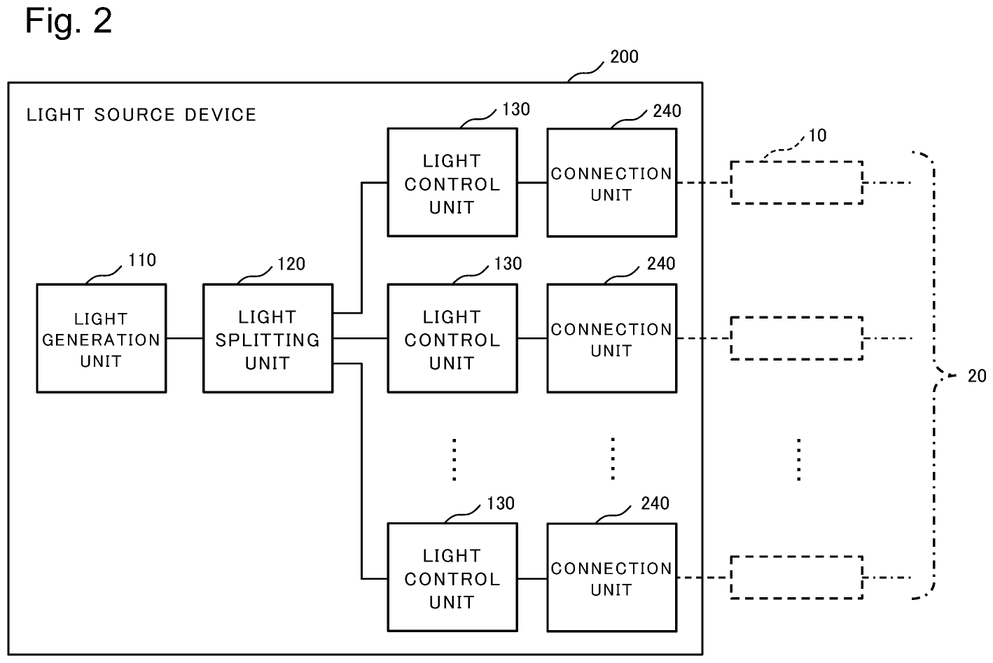

Next, a second example embodiment of the present invention is described. FIG. 2 illustrates a configuration of a light source device 200 according to the present example embodiment. The light source device 200 further includes a connection unit (connection means) 240, in addition to a light generation unit (light generation means) 110, a light splitting unit (light splitting means) 120, and a light control unit (light control means) 130. The light source device 200 is suitably used in an optical submarine cable system.

The light generation unit 110 generates an amplified spontaneous spontaneous emission light into a plurality of split lights. Further, the light control unit 130 controls a band and power of at least one of the plurality of split lights to generate a waveform-shaped split light.

The connection unit 240 is configured to introduce the waveform-shaped split light into each of a plurality of interface devices 10 provided to a plurality of light transmission paths 20. Typically, as the connection unit 240, an optical adapter that connects optical fibers through which the waveform-shaped split light is propagated may be used.

Each of the plurality of light transmission paths 20 includes an optical fiber transmission path. Each of the optical fiber transmission paths may form a fiber pair (FP) including an up-link optical fiber and a down-link optical fiber.

Herein, the light control unit 130 may be configured to control the band and the power of at least one of the plurality of split lights, according to characteristics of one of the plurality of light transmission paths 20. Specific description is given below with reference to the drawings.

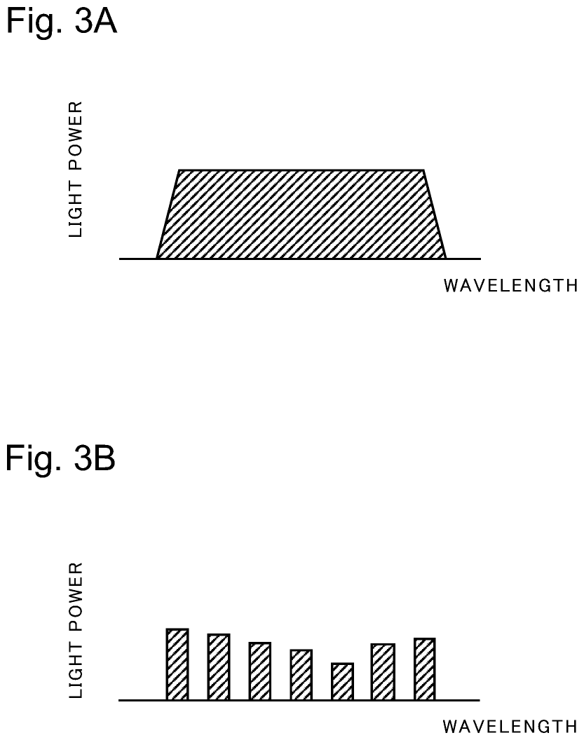

As illustrated in FIG. 3A, the amplified spontaneous emission (ASE) light that is generated by the light generation unit 110 is an amplified spontaneous emission light having a continuous and broad light spectrum. The amplified spontaneous emission light is split by the light splitting unit 120 into a plurality of split lights, and then each of the split light is introduced into the light control unit 130. Subsequently, the light control unit 130 controls the band and the power of the split light to generate the waveform-shaped split light.

When the waveform-shaped split light is introduced as a dummy light into the light transmission path 20 through which a main signal light is propagated, there may be an influence caused by wavelength dependency of a loss and a gain in the optical fiber transmission path constituting the light transmission path 20 or in an optical amplifier included in a submarine repeater. In view of this, in the light source device 200 according to the present example embodiment, the light control unit 130 is configured to control the band and the power of the split light, according to characteristics of the light transmission path 20 in such a way as to compensate the wavelength dependency.

Specifically, for example, as illustrated in FIG. 3B, the light control unit 130 controls the band of the split light to one of an odd-numbered channel and an even-numbered channel in a wavelength division multiplexing (WDM) method, and shapes a comb-like waveform. Further, there may be adopted a configuration in which a height of the power level of the split light can be controlled for each channel. By using the waveform-shaped split light thus shaped, adjustment can be performed in such a way that a ratio of a light signal to a noise (Optical Signal to Noise Ratio: OSNR) on the reception side is constant at each channel.

Next, a control light generation method according to the present example embodiment is described.

In the control light generation method according to the present example embodiment, first an amplified spontaneous emission light is generated. Subsequently, the amplified spontaneous emission light is split into a plurality of split lights. After that, the band and the power of at least one of the plurality of split lights are controlled to generate a waveform-shaped split light. The configuration described above is similar to the control light generation method according to the first example embodiment.

Further, in the control light generation method according to the present example embodiment, the waveform-shaped split light is input into each of a plurality of interface devices provided to a plurality of light transmission paths. In this case, there may be adopted a configuration in which, when the waveform-shaped split light is generated, the band and the power of at least one of the plurality of split lights are controlled according to characteristics of one of the plurality of light transmission paths.

As described above, according to the light source device 200 and the control light generation method of the present example embodiment, a size increase and a cost increase of the device can be avoided even when a control light is introduced into a plurality of light transmission paths.

### Third Example Embodiment

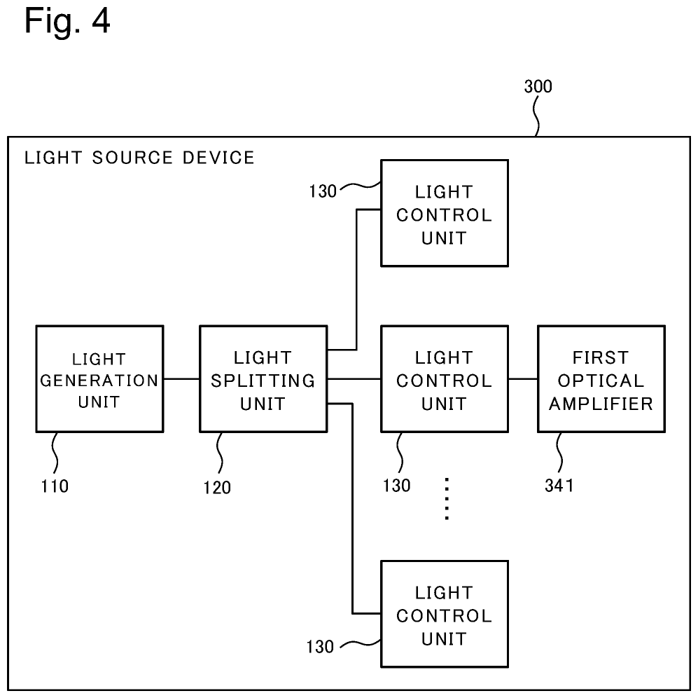

Next, a third example embodiment of the present invention is described. FIG. 4 illustrates a configuration of a light source device 300 according to the present example embodiment. The light source device 300 further includes a first optical amplifier (first optical amplifying means) 341, in addition to a light generation unit (light generation means) 110, a light splitting unit (light splitting means) 120, and a light control unit (light control means) 130. The light source device 300 is suitably used in an optical submarine cable system.

The light generation unit 110 generates an amplified spontaneous spontaneous emission light into a plurality of split lights. The light control unit 130 controls a band and power of at least one of the plurality of split lights to generate a waveform-shaped split light. Further, the first optical amplifier 341 is configured to amplify the waveform-shaped split light.

In the light source device 300 of the present example embodiment, the light splitting unit 120 splits the amplified spontaneous emission light into the plurality of split lights, and the light control unit 130 generates the waveform-shaped split light from the split light. Therefore, the light power of the waveform-shaped split light is reduced from the light power of the amplified spontaneous emission light. Thus, in some cases, the light power of the waveform-shaped split light is insufficient as light power required for a device in the latter step.

However, even in such a case, the light source device 300 of the present example embodiment includes the first optical amplifier 341 configured to amplify the waveform-shaped split light, and hence a control light having light power required for a device in the latter step can be supplied. Note that, the light source device 300 may be configured to include the first optical amplifier 341 only in a light path associated with a predetermined device in the latter step among the light paths for the plurality of split lights. Herein, the predetermined device in the latter step is a device in the latter step that requires an input of a control light having light power exceeding the light power of the waveform-shaped split light.

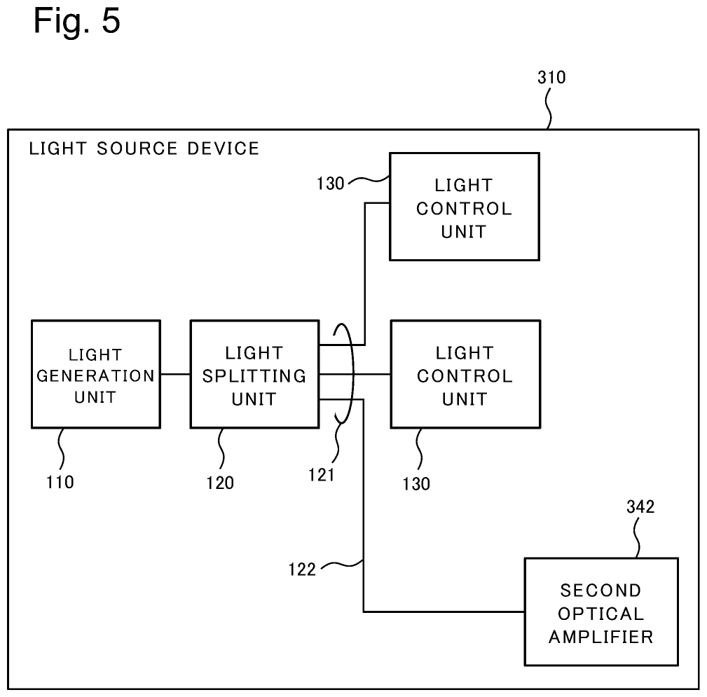

FIG. 4 illustrates a configuration in which each of the plurality of split lights after splitting performed by the light splitting unit 120 is introduced into the light control unit 130. However, the configuration is not limited thereto, and there may be adopted a configuration in which, as in a light source device 310 illustrated in FIG. 5, a light path 122 that does not involve the light control unit 130 is provided among a plurality of light paths 121 for the split lights. With this, the number of the light control units 130 can be reduced, and hence a size reduction and a cost reduction of the device can be achieved. Note that, as illustrated in FIG. 5, there may be adopted a configuration in which the light path 122 that does not involve the light control unit 130 is provided with a second optical amplifier (second optical amplifying means) 342. Herein, the second optical amplifier 342 is configured to amplify at least one of the plurality of split lights.

Next, a control light generation method according to the present example embodiment is described.

In the control light generation method according to the present example embodiment, first an amplified spontaneous emission light is generated. Subsequently, the amplified spontaneous emission light is split into a plurality of split lights. After that, the band and the power of at least one of the plurality of split lights are controlled to generate a waveform-shaped split light. The configuration described above is similar to the control light generation method according to the first example embodiment.

In the control light generation method according to the present example embodiment, there is further adopted a configuration in which the waveform-shaped split light is amplified. Further, in the control light generation method according to the present example embodiment, there may be adopted a configuration in which at least one of the plurality of split lights is amplified.

As described above, according to the light source devices 300 and 310, and the control light generation method of the present example embodiment, a size increase and a cost increase of the device can be avoided even when a control light is introduced into a plurality of light transmission paths. Moreover, the control light having light power required for a device in the latter step can be supplied.

### Fourth Example Embodiment

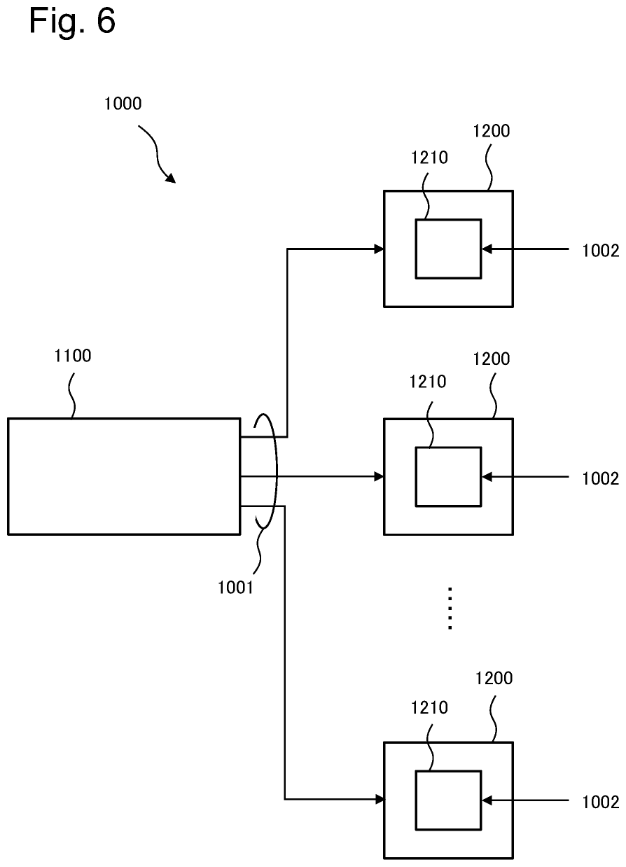

Next, a fourth example embodiment of the present invention is described. FIG. 6 illustrates a configuration of an optical device 1000 according to the present example embodiment. The optical device 1000 includes a device 1100 and a plurality of interface devices 1200 provided to a plurality of light transmission paths. The optical device 1000 is suitably used in an optical submarine cable system.

As the optical light source device 1100, any one of the optical light source device 100 according to the first example embodiment, the optical light source device 200 according to the second example embodiment, and the optical light source devices 300 and 310 according to the third example embodiment may be used. Therefore, the optical light source device 1100 is capable of generating at least one waveform-shaped split light. FIG. 6 illustrates a case in which a plurality of waveform-shaped split lights 1001 are generated. The waveform-shaped split light 1001 can be introduced into each of the plurality of light transmission paths, and can be used as a control light (dummy light).

Each of the plurality of interface devices 1200 includes a light multiplexing unit (light multiplexing means) 1210 that multiplexes the waveform-shaped split light 1001 and a main signal light 1002. Typically, as the light multiplexing unit 1210, an optical coupler may be used.

Next, a transmission light generation method according to the present example embodiment is described.

In the transmission light generation method according to the present example embodiment, first, a waveform-shaped split light is generated. Subsequently, the waveform-shaped split light and a main signal light are multiplexed. Herein, at the time of generating the waveform-shaped split light, a control light generation method being any one of the control light generation methods according to the first example embodiment to the third example embodiment may be used.

With the configuration described above, according to the optical device 1000 and the transmission light generation method of the present example embodiment, a size increase and a cost increase of the device can be avoided even when a control light is introduced into a plurality of light transmission paths.

Note that, a part or the entirety of the example embodiments described above may be described as in the following supplementary notes, but is not limited to the following.

(Supplementary Note 1) An optical light source device including a light generation means for generating an amplified spontaneous emission light, a light splitting means for splitting the amplified spontaneous emission light into a plurality of split lights, and a light control means for controlling a band and power of at least one of the plurality of split lights and generating a waveform-shaped split light.

(Supplementary Note 2) The optical light source device according to Supplementary Note 1, further including a connection means for introducing the waveform-shaped split light to each of a plurality of interface devices provided to each of a plurality of light transmission paths.

(Supplementary Note 3) The optical light source device according to Supplementary Note 2, wherein the light control means controls a band and power of at least one of the plurality of split lights, according to a characteristic of one of the plurality of light transmission paths.

(Supplementary Note 4) The optical light source device according to any one of Supplementary Notes 1 to 3, further including a first optical amplifying means for amplifying the waveform-shaped split light.

(Supplementary Note 5) The optical light source device according to any one of Supplementary Notes 1 to 4, further including a second optical amplifying means for amplifying at least one of the plurality of split lights.

(Supplementary Note 6) The optical light source device according to any one of Supplementary Notes 1 to 5, wherein the light generation means includes a light waveguide having a core containing a rare earth element, and an excitation laser that generates an excitation light for exciting the rare earth element.

(Supplementary Note 7) The optical light source device according to any one of Supplementary Notes 1 to 6, wherein the light control means includes a wavelength selective switch.

(Supplementary Note 8) An optical device including the optical light source device according to any one of Supplementary Notes 1 to 7, and a plurality of interface devices provided to each of a plurality of light transmission paths, wherein each of the plurality of interface devices includes a light multiplexing means for multiplexing the waveform-shaped split light and a main signal light.

(Supplementary Note 9) A control light generation method including generating an amplified spontaneous emission light, splitting the amplified spontaneous emission light into a plurality of split lights, and controlling a band and power of at least one of the plurality of split lights and generating a waveform-shaped split light.

(Supplementary Note 10) The control light generation method according to Supplementary Note 9, further including introducing the waveform-shaped split light into each of a plurality of interface devices provided to each of a plurality of light transmission paths.

(Supplementary Note 11) The control light generation method according to Supplementary Note 10, wherein the generating the waveform-shaped split light includes controlling a band and power of at least one of the plurality of split lights, according to a characteristic of one of the plurality of light transmission paths.

(Supplementary Note 12) The control light generation method according to any one of Supplementary Notes 9 to 11, further including amplifying the waveform-shaped split light.

(Supplementary Note 13) The control light generation method according to any one of Supplementary Notes 9 to 12, further including amplifying at least one of the plurality of split lights.

(Supplementary Note 14) The control light generation method according to any one of Supplementary Notes 9 to 13, wherein the generating the amplified spontaneous emission light includes exciting a rare earth element contained in a core of a light waveguide with an excitation light.

(Supplementary Note 15) The control light generation method according to any one of Supplementary Notes 9 to 14, wherein the generating the waveform-shaped split light includes adjusting power of at least one of the plurality of split lights for each wavelength.

(Supplementary Note 16) A transmission light generation method including generating the waveform-shaped split light by the control light generation method according to any one of Supplementary Notes 9 to 15, and multiplexing the waveform-shaped split light and a main signal light.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

100, 200, 300, 310 Optical light source device
110 Light generation unit
120 Light splitting unit
121 Plurality of light paths
122 Light path
130 Light control unit
240 Connection unit
341 First optical amplifier
342 Second optical amplifier
10 Interface device
20 Light transmission path
1000 Optical device
1001 Waveform-shaped split light
1002 Main signal light
1100 Optical light source device
1200 Interface device
1210 Light multiplexing unit

What is claimed is:

1. An optical light source device comprising:
a light generation circuit configured to generate an amplified spontaneous emission light;
a light splitting circuit configured to split the amplified spontaneous emission light into a plurality of split lights; and
a light control circuit configured to control a band and power of at least one of the plurality of split lights and generate a waveform-shaped split light.

2. The optical light source device according to claim 1, further comprising
a connection circuit configured to introduce the waveform-shaped split light to each of a plurality of interface devices provided to each of a plurality of light transmission paths.

3. The optical light source device according to claim 2, wherein
the light control circuit controls a band and power of at least one of the plurality of split lights, according to a characteristic of one of the plurality of light transmission paths.

4. The optical light source device according to claim 1, further comprising
a first optical amplifying circuit configured to amplify the waveform-shaped split light.

5. The optical light source device according to claim 1, further comprising
a second optical amplifying circuit configured to amplify at least one of the plurality of split lights.

6. The optical light source device according to claim 1, wherein
the light generation circuit includes a light waveguide having a core containing a rare earth element, and an excitation laser that generates an excitation light for exciting the rare earth element.

7. The optical light source device according to claim 1, wherein
the light control circuit includes a wavelength selective switch.

8. An optical device comprising:
the optical light source device according to claim 1; and a plurality of interface devices provided to each of a plurality of light transmission paths, wherein
each of the plurality of interface devices includes a light multiplexing circuit configured to multiplex the waveform-shaped split light and a main signal light.

9. A control light generation method comprising:
generating an amplified spontaneous emission light;
splitting the amplified spontaneous emission light into a plurality of split lights; and
controlling a band and power of at least one of the plurality of split lights and generating a waveform-shaped split light.

10. The control light generation method according to claim 9, further comprising
introducing the waveform-shaped split light into each of a plurality of interface devices provided to each of a plurality of light transmission paths.

11. The control light generation method according to claim 10, wherein
the generating the waveform-shaped split light includes controlling a band and power of at least one of the plurality of split lights, according to a characteristic of one of the plurality of light transmission paths.

12. The control light generation method according to claim 9, further comprising
amplifying the waveform-shaped split light.

13. The control light generation method according to claim 9, further comprising
amplifying at least one of the plurality of split lights.

14. The control light generation method according to claim 9, wherein
the generating the amplified spontaneous emission light includes exciting a rare earth element contained in a core of a light waveguide with an excitation light.

15. The control light generation method according to claim 9, wherein
the generating the waveform-shaped split light includes adjusting power of at least one of the plurality of split lights for each wavelength.

16. A transmission light generation method comprising:
generating the waveform-shaped split light by the control light generation method according to claim 9; and
multiplexing the waveform-shaped split light and a main signal light.
